(19) United States
(12) Patent Application Publication
(10) Pub. No.: US 2017/0182569 A1
(43) Pub. Date: Jun. 29, 2017

(54) SAWING MACHINE FOR STEEL BAR STOCK

(71) Applicant: WRJB Holdings, LLC, Grandville, MI (US)

(72) Inventor: William A. Casemier, Grandville, MI (US)

(21) Appl. No.: 15/389,887

(22) Filed: Dec. 23, 2016

Related U.S. Application Data
(60) Provisional application No. 62/387,389, filed on Dec. 24, 2015.

(51) Int. Cl. B23D 47/04; B23D 47/06; B23D 59/00; B23D 45/00

(52) U.S. Cl. CPC B23D 47/045; B23D 45/003; B23D 47/06; B23D 59/001

(57) ABSTRACT

A sawing machine for cutting steel bar stock includes a rack assembly that has a plurality of stalls that are each configured to hold at least one elongated piece of metal in generally parallel alignment with the others. A chain drive is coupled with the plurality of stalls and is operable to move the plurality of stalls to align a selected stall of the plurality of stalls with a pushing position. A saw is arranged at or near a first end of the rack assembly and has a saw blade positioned perpendicular to the elongated pieces of metal held by the rack assembly. A pusher device is operable to linearly move a pusher member from a second end of the rack assembly toward the first end, such that the elongated piece of metal held by the selected stall is move by the pusher device to a desired cutting position.

### CROSS REFERENCE TO RELATED APPLICATION

The present application claims the filing benefits of U.S. provisional application Ser. No. 62/387,389, filed Dec. 24, 2015, which is hereby incorporated herein by reference in its entirety.

### FIELD OF THE INVENTION

The present invention relates generally to the field of metal stock storage and automated saws.

### BACKGROUND OF THE INVENTION

It is relatively common for machine shops and fabricators to store metal bar and rod stock on stationary shelves and racks that can be accessed by individuals when a need arises for a particular part. Typically, machinists and fabricators manually remove a long piece of the bar or rod stock for the dimension and metal type needed, then rough cut a section off of the long piece of stock, and thereafter make a square cut at the precise length desired. This manual process can not only be a distraction from fabrication projects, but also can result in excessive material and energy waste, errors, and confusion, such as when multiple projects or workers are trying to obtain a similar piece of metal bar or rod stock.

### SUMMARY OF THE INVENTION

The present invention provides a sawing machine for steel or other metal stock that can be fully or partially automated to fulfill specific orders for metal pieces that are cut at desired lengths. The metal stock may include bar, rod, and structural metal pieces. The sawing machine includes a rack assembly that has a plurality of stalls that are each configured to hold at least one elongated piece of metal in generally parallel alignment with elongated pieces of metal held by the adjacent stalls. A chain drive may be coupled with the plurality of stalls and operate to move the plurality of stalls and position a selected stall in a pushing position. The sawing machine also includes a saw arranged at or near an end of the rack assembly and positioned to cut off a section of one of the elongated pieces of metal held by the rack assembly. Further, the sawing machine includes a pusher device that may have a pusher member coupled with a powered actuator, which operates to linearly move the pusher member from an end of the rack assembly toward the saw. The pusher member is aligned with the selected stall in the pushing position to contact an end of the elongated piece of metal held by the selected stall and move the elongated piece of metal to a desired cutting position.

The sawing machine may also have a controller that is operable to receive a part order input from a user, which identifies a desired piece of metal with a desired length. Based on the part order input, the controller can operate to identify the selected stall of the plurality of stalls having the desired piece of metal. The controller may actuate the chain drive to move the selected stall to the pushing position, and actuate the pusher device to move the desired piece of metal to the desired cutting position, whereby a portion of the desired piece of metal extends past the saw blade the desired length.

Optionally, the elongated pieces of metal held by the plurality of stalls may have different characteristics, such as gauge, length, and material type, which may be stored by the controller and automatically updated after the saw cuts off a piece of metal. Optionally, the part order input may also include a desired quantity, such that the controller may actuate the pusher and the saw to cut the desired piece of metal at the desired length multiple times to provide the desired quantity.

Optionally, the controller may be configured to receive and process a plurality of part orders having a different desired material, length, and/or quantity. Further, the controller may be operable to determine whether the elongated pieces of metal held on the rack assembly are adequate to satisfy the part order, and optionally, generate an alert to the user when contents of the rack assembly are insufficient to satisfy the part order.

Optionally, the plurality of stalls of the rack assembly may include a first and second set of vertically arranged shelves that generally counterbalance each other when loaded with similarly weighted metal stock. In such an arrangement, movement of the first set of vertically arranged shelves upward may causes the second set of vertically arranged shelves to move downward a substantially equal distance. Optionally, the pusher device may include a chain drive that extends longitudinally between the first and second sets of vertically arranged shelves. Optionally, the pusher member may be pivotal about a longitudinal axis between a first position that engages an elongated piece of metal on the first set of vertically arranged shelves and a second position that engages an elongated piece of metal on the second set of vertically arranged shelves.

Optionally, the sawing machine may include a length locator or secondary pusher arranged on an opposing side of the circular saw from the rack assembly. The length locator may have a locator arm that is movable to a stop position based on the desired length to provide a precise length adjustment, such that the locator arm abuts an end of the desired piece of metal opposite the end engaged by the pusher member.

Optionally, the sawing machine may include a vise arranged at or near the saw and configured to engage a side of the desired piece of metal in the desired cutting position, allowing the saw to make a clean and square cut through the desired piece of metal. The vise may be movable to a resistance position that engages the side of the desired piece of metal at a first pressure that is overcome by the pusher device to prevent moving the desired piece of metal past the desired cutting position, and further may be moveable to a secure position that applies a greater pressure when the desired piece of metal is in the desired cutting position.

These and other objects, advantages, purposes and features of the present invention will become apparent upon review of the following specification in conjunction with the drawings.

### BRIEF DESCRIPTION OF THE DRAWINGS

FIG. 1 is an upper perspective view of a sawing machine in accordance with one embodiment of the present invention;

FIG. 2 is a side elevational view of the sawing machine of FIG. 1;

FIG. 3 is a top plan view of the sawing machine of FIG. 1;

FIG. 4 is an end elevational view of the sawing machine of FIG. 1;

FIG. 5 is an upper perspective view of a rack assembly of the sawing machine shown in FIG. 1;

FIG. 6 is an end elevational view of the rack assembly of FIG. 5;

FIG. 7 is a top plan view of the rack assembly of FIG. 5;

FIG. 8 is a side elevational view of the rack assembly of FIG. 5;

FIG. 9 is an upper perspective view of a polymer sheet disposed along a series of shelf member of an embodiment of a rack assembly;

FIG. 10 is an upper perspective view of an intermediate section of the rack assembly shown in FIG. 5;

FIG. 11 is an upper perspective view of an opposite end section of the rack assembly from that shown in FIG. 10, illustrating a chain drive and motor for operating the rack assembly in accordance with one embodiment of the present invention;

FIG. 12 is an upper perspective view of a pusher device of the sawing machine shown in FIG. 1;

FIG. 13 is an side elevational view of the pusher device of FIG. 12;

FIG. 14 is an top plan view of the pusher device of FIG. 12;

FIG. 15 is a detailed upper perspective view of an end portion of the pusher device of FIG. 12, illustrating a chain drive of the pusher device;

FIG. 16 is another detailed upper perspective view of an end portion of the pusher device of FIG. 12, illustrating a pusher member;

FIG. 17 is an end elevational view of the pusher device of FIG. 12, illustrating the pusher member;

FIG. 18 is an upper perspective view of a pusher member, in accordance with one embodiment of a pusher device;

FIG. 19 is an upper perspective view of a saw and a portion of the end section of the rack assembly of the sawing machine shown in FIG. 1;

FIG. 19A is a detailed view of a section A of FIG. 19, illustrating roller guides between the pusher device and the saw of the sawing machine.

FIG. 20 is a side elevational view of the saw and a length locator of the sawing machine of FIG. 19;

FIG. 21 is a top plan view of the saw and a length locator of the sawing machine of FIG. 19;

FIG. 22 is a detailed upper perspective view of the length locator of FIG. 19;

FIG. 23 is an end elevational view of the length locator of FIG. 22;

FIG. 24 is an upper perspective view of the saw, a vise, and a part collector of the sawing machine shown in FIG. 1;

FIG. 25 is an end elevational view of the saw, vise, and part collector of FIG. 24;

FIG. 26 is a top plan view of the saw, vise, and part collector of FIG. 24;

FIG. 27 is a side elevational view of the saw, vise, and part collector of FIG. 24;

FIG. 28 is an upper perspective view of a motor mount and blade support of the saw shown in FIG. 24;

FIG. 29 is an upper perspective view of a rail assembly and linear screw drive for the saw shown in FIG. 24;

FIG. 30 is an upper perspective view of the blade support of the saw of FIG. 24;

FIG. 31 is an upper perspective view of the vise and the part collector of the sawing machine shown in FIG. 24; and

FIG. 32 is a schematic control diagram for operating the sawing machine in accordance with one embodiment of the present invention.

### DESCRIPTION OF THE PREFERRED EMBODIMENTS

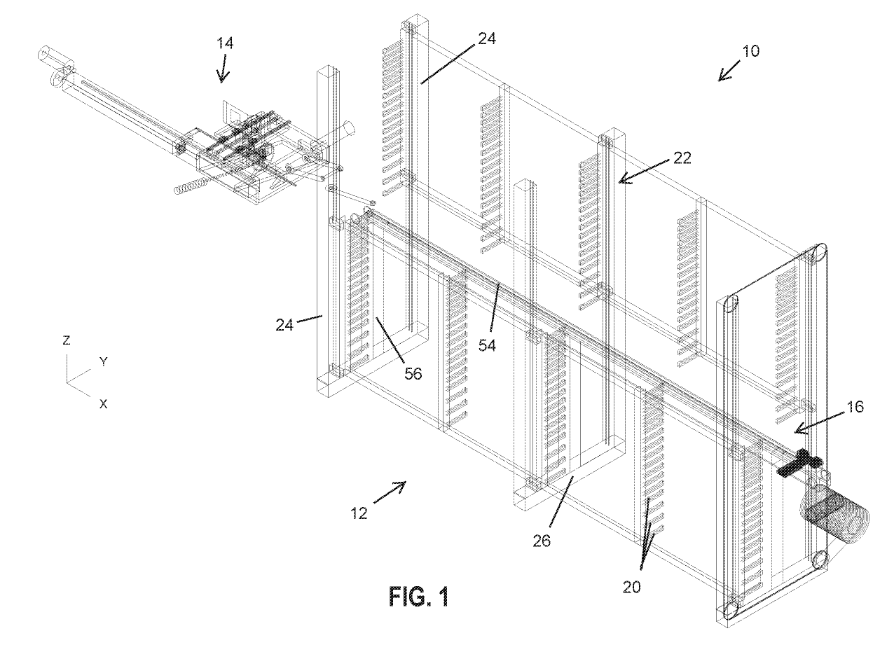

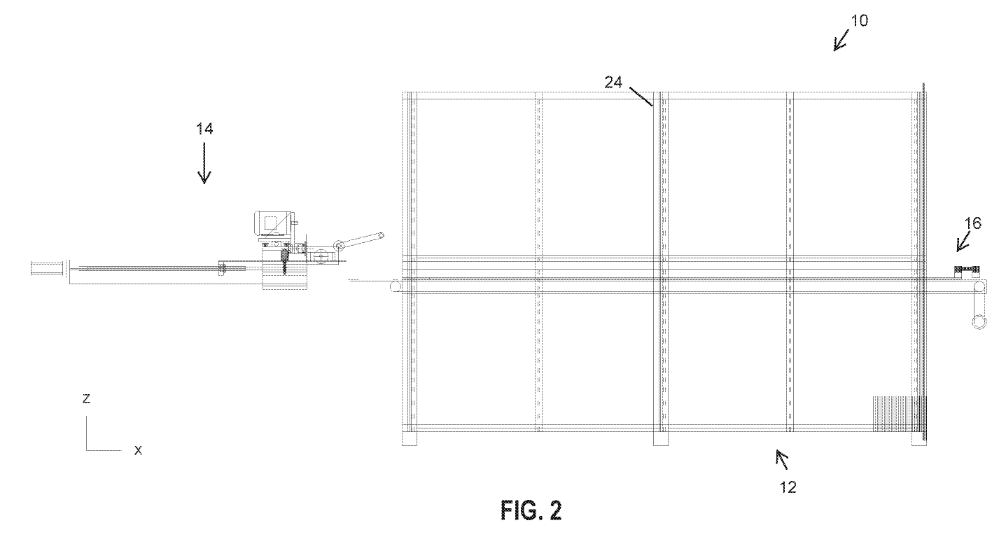

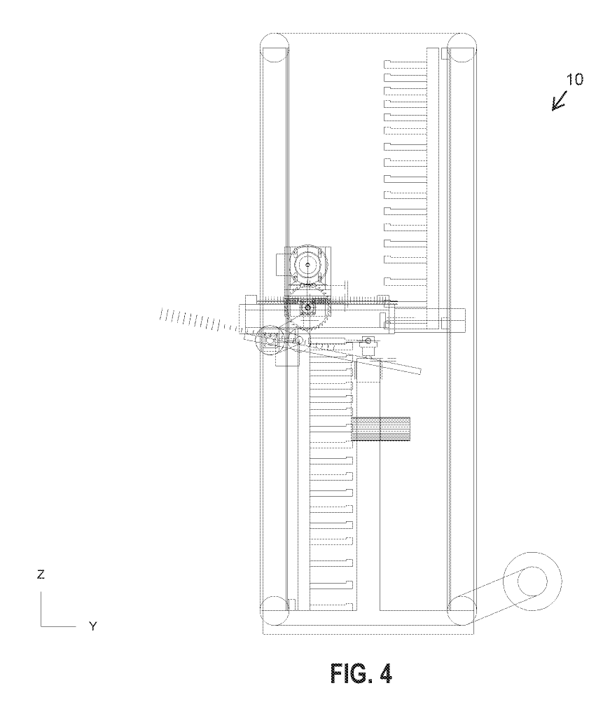

Referring now to the drawings and the illustrative embodiments depicted therein, a sawing machine 10, as shown in FIGS. 1-4, generally includes of a rack assembly 12, a saw assembly 14 arranged at or near an end of the rack assembly 12, and a pusher device 16 that is operable to push an elongated piece of metal at least partially off the rack assembly for cutting by the saw and thereby provide a desired part or portion of the elongated piece of metal. The sawing machine 10 may also include a controller 18 configured to receive a part order input from a user that identifies a desired piece of metal with a desired length. The controller 18 may then identify and select a stall on the rack assembly that holds the the desired piece of metal, and move the selected stall to a pushing position. The controller may further actuate the pusher device 16 to move the desired piece of metal to a desired cutting position, whereby a portion of the desired piece of metal extends past the saw blade for cutting to the desired length.

The rack assembly 12 of the sawing machine 10 has a plurality of stalls 20 or hooks or shelves or the like that are each configured to hold at least one elongated piece of metal. The metal stock may include bar, rod, tubes, and/or structural metal pieces and the like, such as those made from steel. It is also contemplated that elongated stock pieces may be provided that are comprised of other materials, composites, and various types or alloys of metal. The stalls 20 of the rack assembly 12 are arranged such that the elongated stock pieces are held in generally parallel alignment with each other. The rack assembly 12 may include a base structure 22 that rests on a floor or other support surface and that is configured to operably support the plurality of stalls 20, allowing the plurality of stalls 20 to move relative to the base structure for positioning a selected or desired stall in alignment and/or engagement with the pusher device 16.

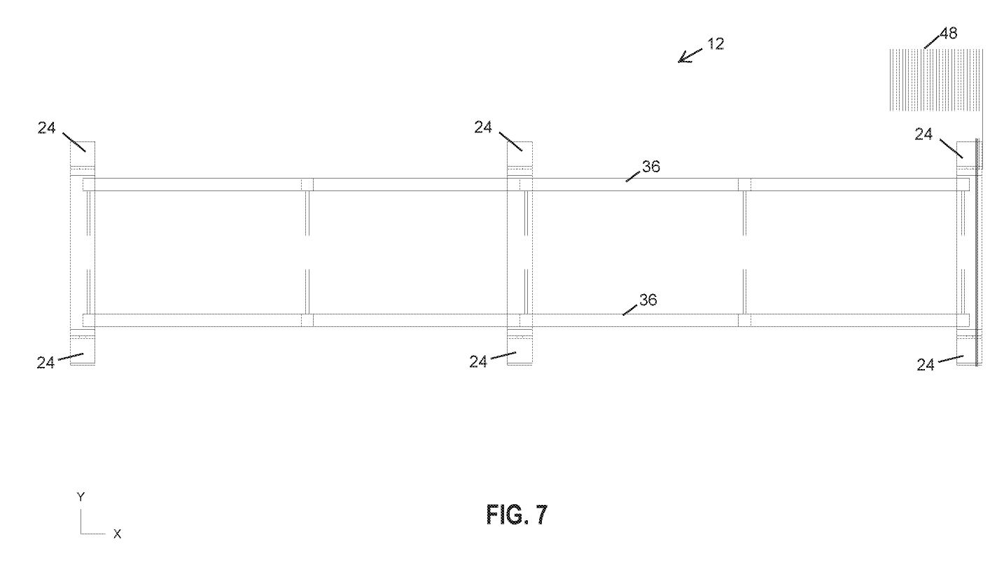

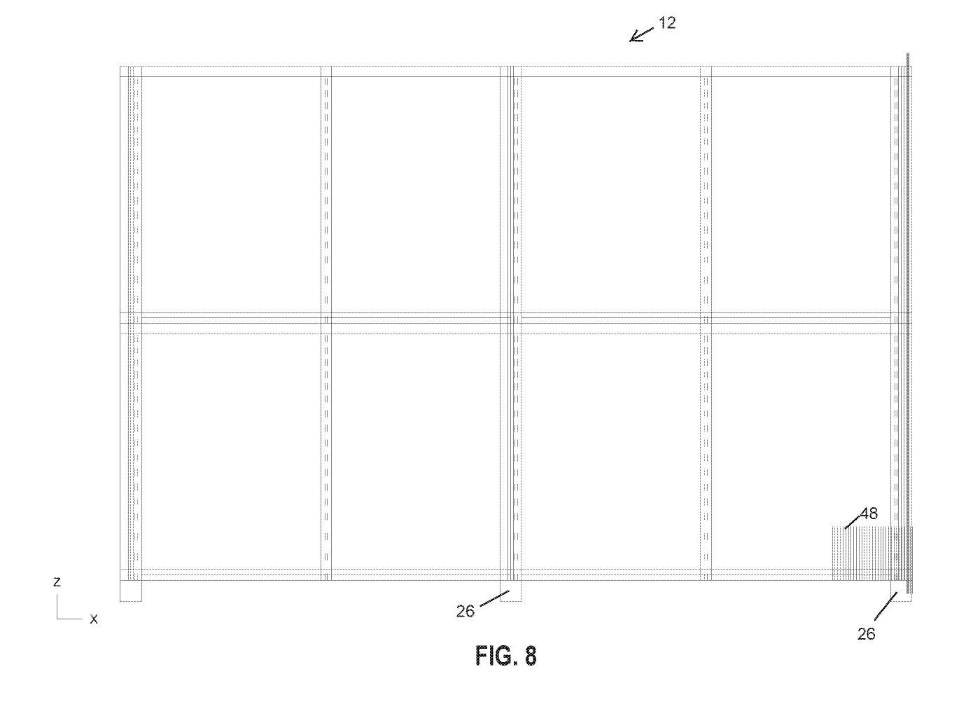

As shown in FIGS. 1-8, the base structure 22 includes outer posts 24 that are vertically positioned at side portions of the rack assembly 12. The outer posts extend vertically upward from end portions of lower cross members 26 that span laterally across the floor surface and under the stalls, whereby each lower cross member 26 together with the two attached outer posts 24 form a generally U-shaped structure. As illustrated, the base structure 22 includes a U-shaped structure at each opposing end section and an additional U-shaped structure spaced between the end sections. The U-shaped structures of the base structure 22 are thereby aligned to define an interior storage area of the rack assembly. Accordingly, the base structure 22 provides a frame that defines opposing longitudinal walls extending in parallel alignment the length of the rack assembly 12. The outer posts 24 of the base structure 22 may be interconnected by additional frame components, and more generally the base structure may include additional cross members, posts, or others frame member to adequately support the arrangement of stalls on rack assembly. It is also understood that the base structure 22 of the rack assembly 12 may be alternatively constructed with other frame designs and configurations that are capable of supporting movement of the stalls relative to the base structure.

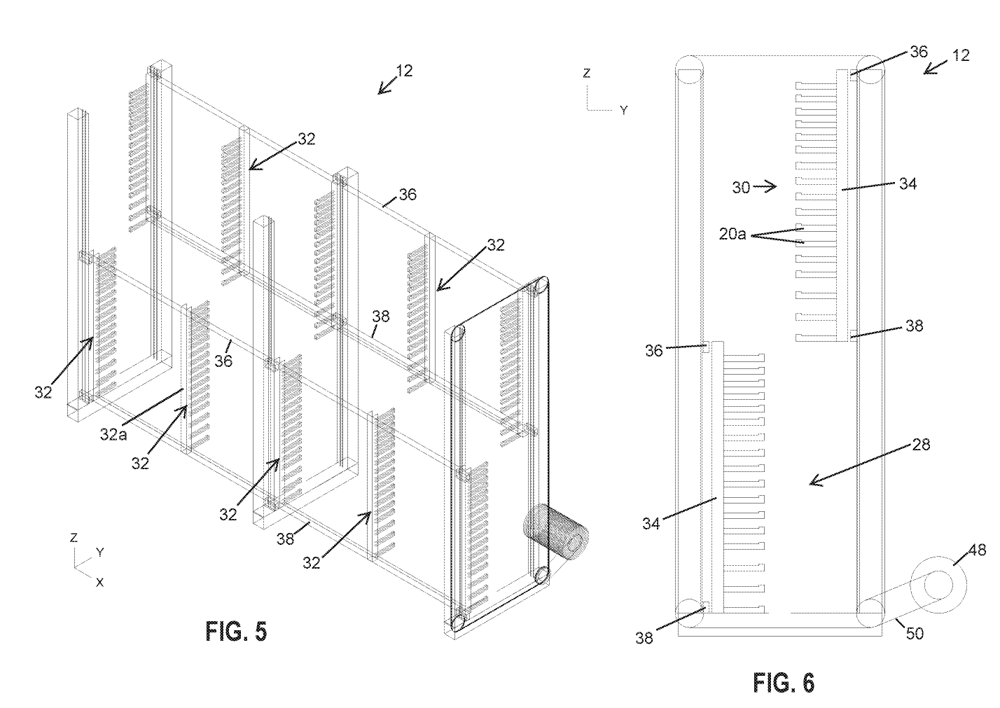

The stalls 20 each include a series of fingers 20a or hooks or the like that are horizontally aligned and arranged at spaced locations along the longitudinal extent of the elongated pieces of metal held by the rack assembly. As illustrated in FIGS. 5-7, the plurality of stalls include a first set 28 and second set 30 of vertically arranged stalls attached to interior portions of the opposing walls or posts 24 of the base structure 22, such that the fingers 20a or hooks of each set of stalls 20 protrude generally inward toward each other. Each of these sets of stalls 20 may include a series of shelf assemblies 32 that are spaced longitudinally along the length of rack assembly 12 and attached to support rails that extend longitudinally along the length of the rack assembly 12.

As illustrated in FIG. 6, the five shelf assemblies 32 on each set of vertically arranged stalls 20, each include a vertical array of fingers 20a or hooks that are attached at spaced locations along a vertical support 34 of the shelf assembly. An upper support rail 36 is then attached at an upper portion of the vertical supports 32a (FIG. 5) of the shelf assemblies 32 and a lower support rail 38 is attached at a lower portion of the vertical supports 32a, forming a horizontally arranged ladder configuration. The fingers 20a or hooks of the shelf assembly 32 are each configured to support an elongated piece of metal in cooperation with the fingers or hooks of the aligned shelf assemblies 32. Accordingly, the vertical spacing of the fingers 20a for each shelf assembly 32 is substantially equal and aligned, although the spacing may be commonly varied for each set of stalls to allow differently sized metal pieces to fit at different stalls. The illustrated embodiment has spacing between the fingers 20a that increases from the upper portion of each shelf assembly 32 toward the lower portion thereof, and in total provides sixteen fingers on each shelf assembly. This spacing, thereby, allows larger gauged or cross-sectionally sized pieces of metal to be held by the lower stalls of the shelf assembly 32 and smaller gauged or cross-sectionally sized pieces of metal to be held by the upper stalls. It is also understood that if similarly gauged or sized metal pieces are intended to held, the spacing between the fingers may be generally equal, and more or fewer stalls may be provided on each set of stalls to accommodate the desired inventory and customization options of the sawing machine.

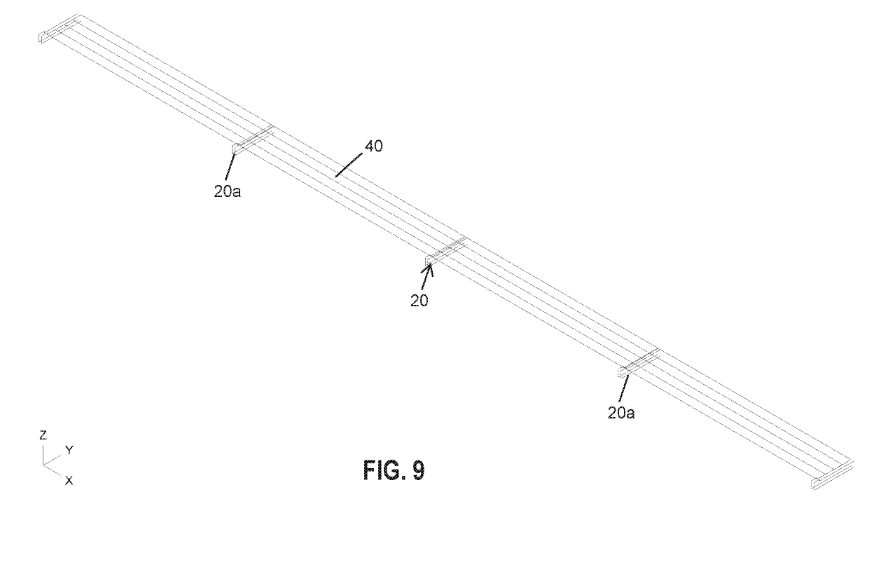

Optionally, the stalls may include a thin sheet or panel of material 40, such as shown in FIG. 9, which spans across and rests on the horizontally aligned fingers 20a of a stall 20 to provide a consistent support surface for the elongated metal pieces. The material of the sheet may be coated or comprise a polymer or other material that has a low coefficient of friction, such as UHMW plastic, to allow the steel pieces to slide or skid more easily relative to the fingers 20a of the rack assembly.

Optionally, the rack assembly may be modular, whereby one or more additional rack sections may be added or removed from the rack assembly to lengthen or shorten the rack assembly, respectively, and thereby accommodate stock pieces of metal with increased or shortened lengths. For example, a single rack assembly may be approximately twelve feet in length to hold twelve foot long metal bar or rod stock (which is a typical length for cold rolled steel), and an additional six or twelve foot section may be added, such as to hold 24 foot length metal (which is a typical length for structural steel, tubing, c-channel, angle iron). Similarly, a single rack assembly may be divided into removable sections or may be otherwise adjusted in length to allow the rack assembly to be customized to a desired length.

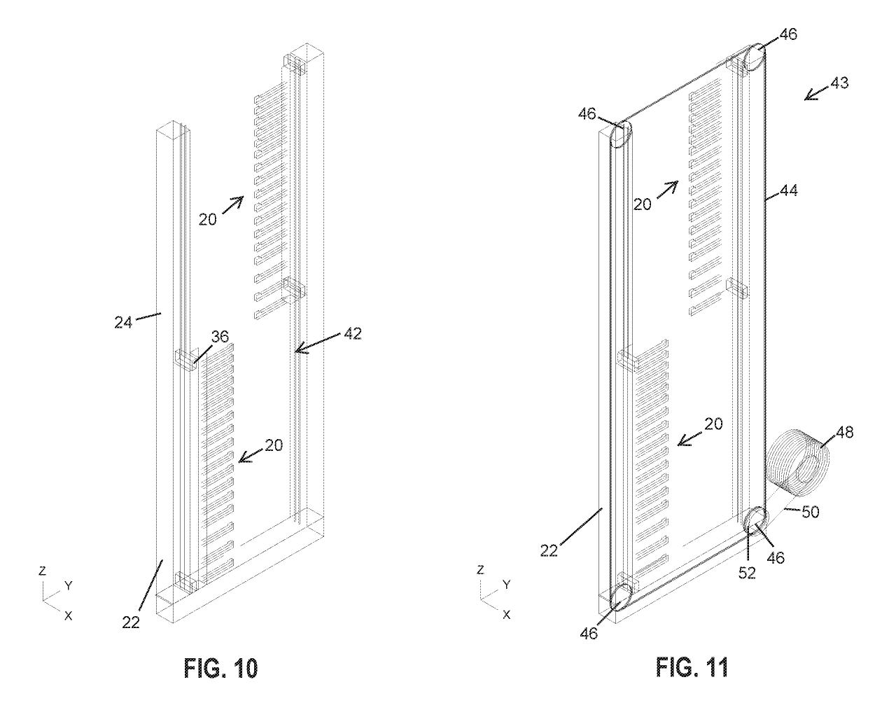

The plurality of stalls 20 are movably supported by the base structure 22 of the rack assembly 12 to allow a selected stall to be positioned for at least partially removing the shelf contents toward the saw assembly 14. As illustrated in FIG. 10, the two sets of the stalls 20 are vertically moveable along the side walls or posts 24 of the base structure 22. More specifically, as shown at an intermediate section of the rack assembly 12 shown in FIG. 10, the support rails 36 that interconnect each shelf assembly may be slidably engaged with the posts 24 of the base structure 22 by a slider assembly 42 or other similar arrangement that supports the stalls 20 in vertical alignment with the posts 24 upon upward and downward movement of the stalls 20. These slider assemblies 42 may be coupled at multiple locations between the sets of stalls 20 and the opposing walls or posts 24 of the base structure 22. It is also contemplated that the stalls of the rack assembly may be moved differently or with additional support along the base frame, such as via a gear and vertically oriented geared rack, among others.

To effectuate movement of the stalls 20 relative to the base structure 22, a rotational drive system 43 (FIG. 11) may be used, such as a belt or chain drive. In one embodiment, each of the plurality of stalls 20 may be attached to a single rotational drive system 43, such that a motor may operably engage the drive system for moving the plurality of stalls and thereby positioning a selected stall of the plurality of stalls 20 to a pushing position. For example, as shown in FIGS. 5, 6, and 11, a chain drive may extend around a periphery of an end section of the rack assembly 12, such that a primary chain loop 44 engages sprockets 46 at or near the top and bottom corners of the base structure 22. In such an arrangement, the two sets of vertically arranged stalls 20 engage the chain drive on opposing sides of the rack assembly 12, allowing the first and second sets of stalls 20 to generally counterbalance each other when loaded with similarly weighted metal stock. Thus, by engaging the stalls 20 to opposing sides sections of the primary chain loop 44, upward movement of the first set of vertically arranged shelves on the stall 20 causes the second set of vertically arranged shelves on the other stall 20 to move downward a substantially equal distance. To provide a full range of movement of sets of stalls 20 and prevent the stalls abutting the upper or lower sprockets 46, the sets of stalls may be engaged to the chain at oppositely spaced distances from the top and bottom of the base structure 22. For example, as shown in FIG. 6, the first set of stalls engages an upper half of the vertical section of the chain drive and the second set of stalls engaging a lower half of the vertical section of the chain drive.

The primary chain drive loop 44 may be driven by at least one motor 48 that is operably engaged with one of the sprockets. As shown in FIG. 11, the motor 48 engages a drive chain 50 that connects to a drive sprocket 52, which is coaxial with a sprocket 46 of the primary chain loop 44. The motor 48 may be a hydraulic motor, a servo motor, or other motor, and the drive chain and/or primary chain loop may be a double leaf chain or other chain or belt configuration that can withstand and operate under the weight of the metal pieces held by the stalls.

Optionally, the stalls 20 may alternatively be manually moved relative to the base structure 22 by pulling or pushing the stalls 20 up or down to position a selected stall of the plurality of stalls 20 to a pushing position. In such a manual arrangement, the two sets of vertically arranged stalls 20 may be counterbalanced by engaging a chain or the like that extends between opposing sides of the rack assembly 12, such as a chain that extends over pulleys or sprockets rotatably attached at the top portion of the base structure 22. The first and second sets of stalls 20 may then generally counterbalance each other when loaded with similarly weighted metal stock, which would require less force to move the stalls 20 to the desired pushing position.

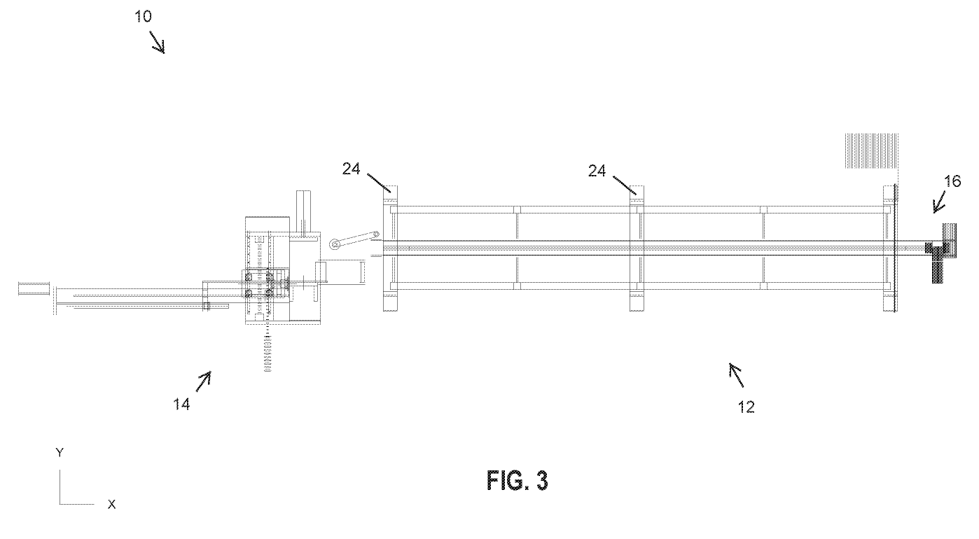

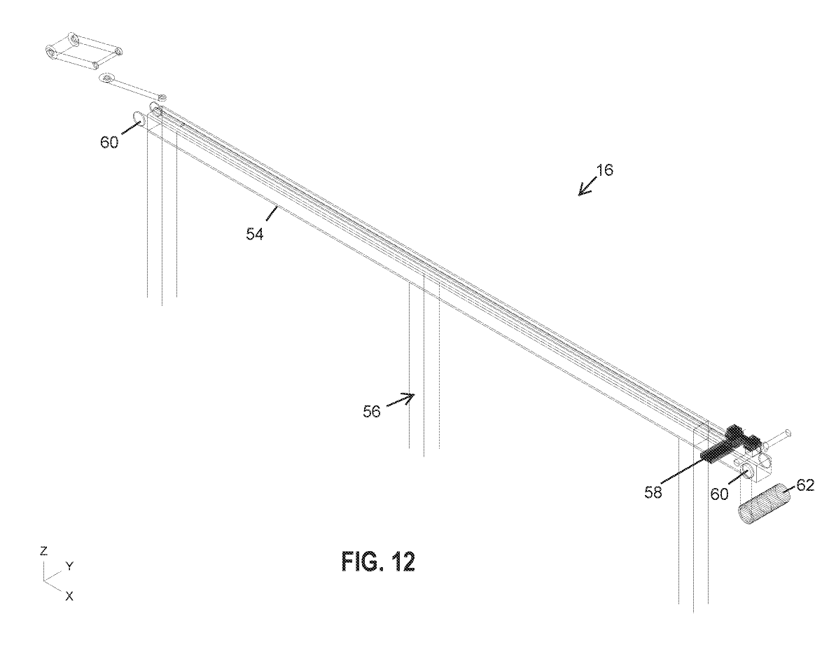

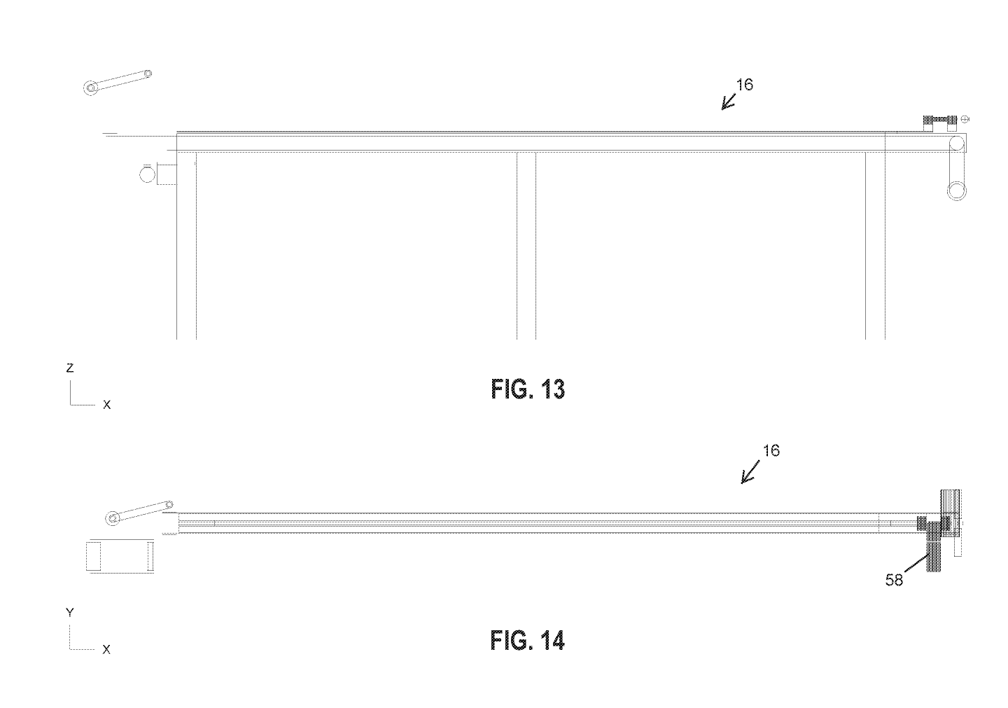

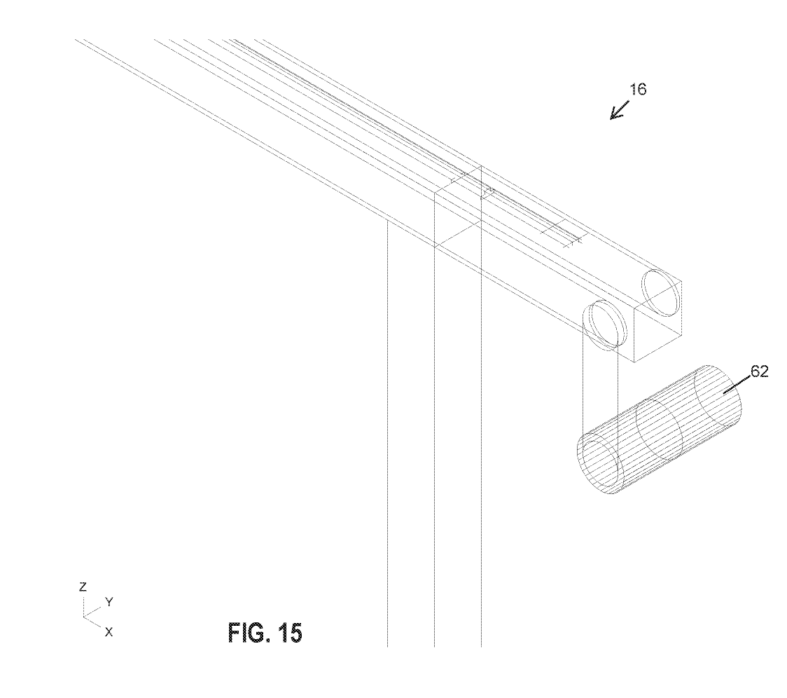

Once the selected or desired stall 20 is moved to a desired pushing position, the pusher device 16 of the sawing machine 10 engages an end of the metal piece held on the selected stall and slides the metal piece at least partially off the selected stall toward the saw of the sawing machine. As illustrated in FIGS. 1 and 3, the pusher device 16 may include a chain drive 54 supported by a pusher frame 56 that extends longitudinally between the first and second sets of vertically arranged shelves, at a generally centered height between the upper and lower portions of the rack assembly. More specifically, the chain drive may be supported at a centered height by the pusher frame to allow a pusher member 58 to selectively engage the first or second set of stalls. The pusher device 16, as shown in FIGS. 12-15, includes the pusher member 58 coupled with the chain drive of the pusher device. The chain drive 54 is aligned with the elongated metal pieces held by the rack assembly 12, and is thereby horizontally arranged and extending between opposing sprockets 60 coupled with the pusher frame 56. The pusher device 16 may also include intermediate sprockets or idler pulleys coupled with the pusher frame 56 along the length of the chain drive to hold up the chain in horizontal alignment with the stalls. Further, due to the substantially linear force exerted by the pusher member 58 at the metal pieces held by the rack assembly 12, the drive chain 54 may include two chains extending in parallel on both sides of the pusher frame to reduce torsion and increase stability of the pusher member. The motor 62 of the pusher device, as shown in FIG. 15, will likely be a hydraulic motor, but may also be a servo motor, or other motor. To compensate for different weights of the steel bar stock, the hydraulic pusher motor 62 may be driven by a series of valves provide the necessary force at the pusher member 58. Further, it is contemplated that once the desired stall 20 is moved to a desired pushing position, the pusher member may be manually operated or the metal piece in the desired stall may be otherwise manually moved toward the saw of the sawing machine to the desired cutting position.

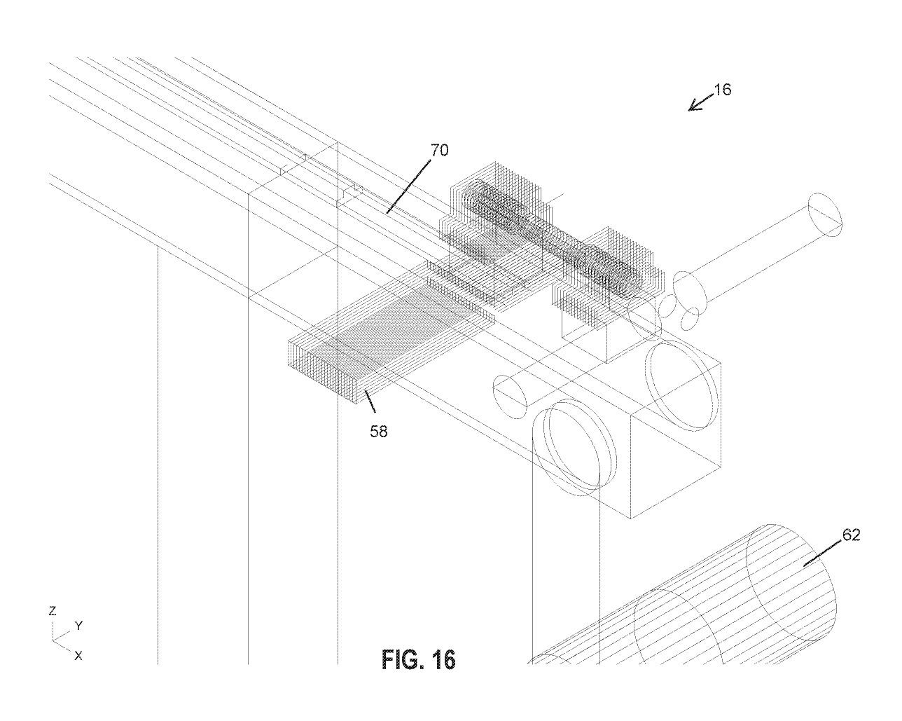

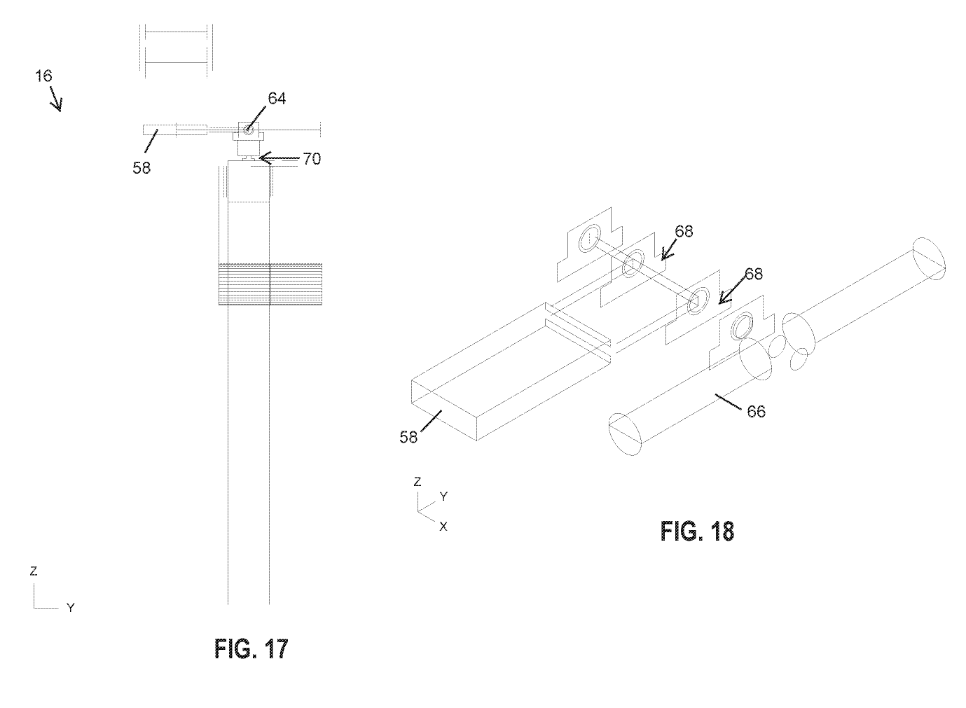

As shown in FIGS. 16-18, the pusher member 58 may be pivotal about a longitudinal axis 64 between a first position that engages an elongated piece of metal on the first set of vertically arranged shelves or stalls 20 and a second position that engages an elongated piece of metal on the second set of vertically arranged shelves or stalls 20. The pusher member 58 may thereby rotate 180 degrees to push stock on the left side stalls or the right side stalls. To automate the rotation of the pusher member 58, a flip-flop air cylinder 66 may be coupled with on the pusher member 58. Also, bearing bocks 68 may be provided along a guide shaft 70 running through the pusher member 58 and along the extent of the pusher frame 56. Similar to the rack assembly 12, it is also contemplated that the pusher member may have a different movable or sliding connection along the pusher frame, and the pusher frame may be alternatively constructed.

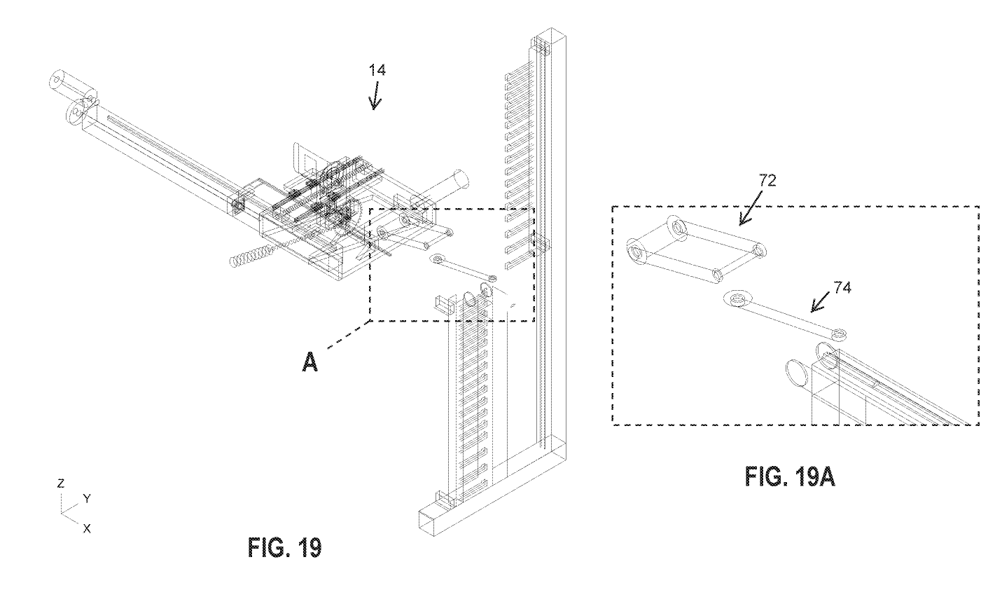

When the elongated pieces of metal are pushed, at least partially, off the selected stall, the pieces may be guided to the saw assembly 14 by roller guides between the rack assembly and the saw. The roller guides may include a top guide 72 and a side guide 74, as shown in FIGS. 19 and 19A. One or more of the guides may have a sensor to provide the controller with a signal to determine when the bar is getting close to the sawing assembly. Also, the guides may have an air cylinder, spring, or other resistance device to push the bar against the receiving portion of the saw assembly 14, as the bar approaches the cutting position.

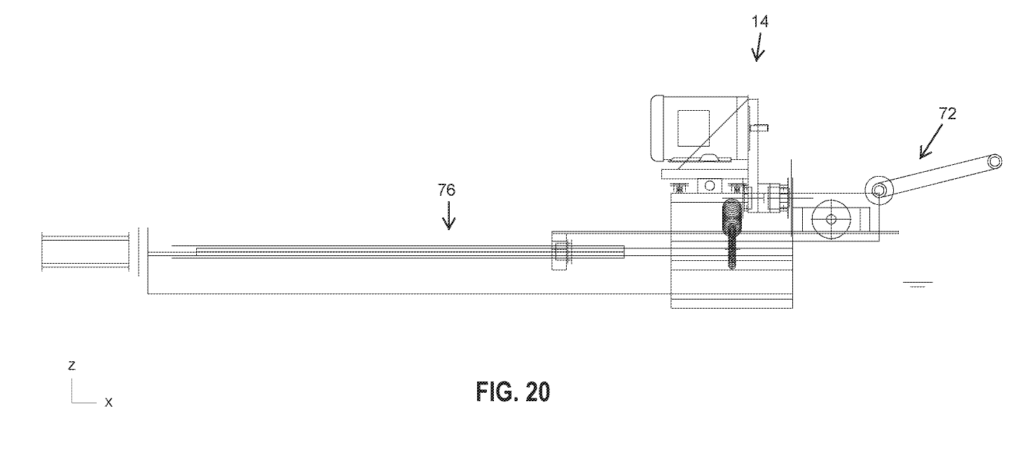

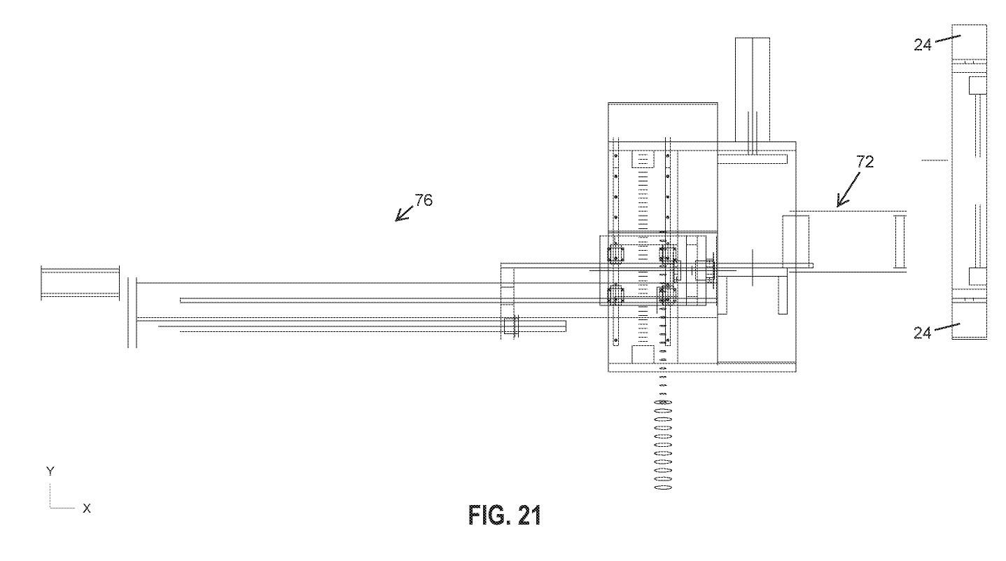

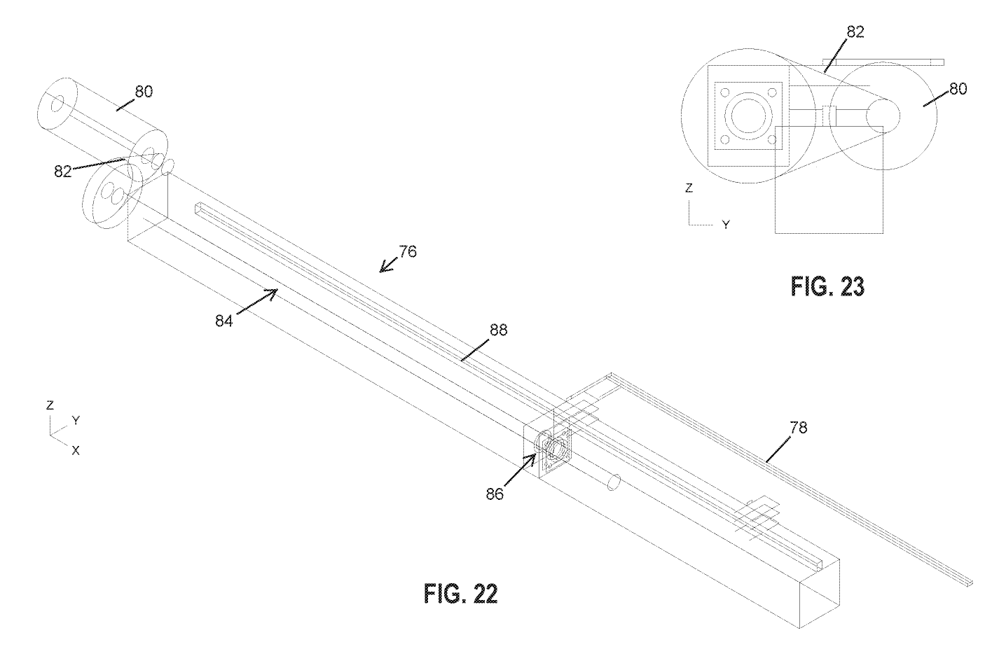

When the metal piece enters the receiving portion of the saw assembly 14, a length locator 76 or secondary pusher may engage the opposing end of the metal piece from the pushing device to guide the metal piece to a precise cutting position. As shown in FIGS. 20-23, one example of a length locator 76 is illustrated on an opposing side of the saw from the rack assembly 12. The length locator 76 may have a locator arm 78 that is positioned to abut an end of the desired piece of metal and may be movable to a stop position or cutting position based on the desired length to be cut from the metal piece. To provide a precise length adjustment, the locator arm 78 is moved to the cutting position by a servo motor 80 that is operably engaged, such as via a timing belt 82, to rotate a ball screw 84, which drives a ball nut 86 that is prevented from rotating by a linear rail 88, and thus imparting linear movement to the locator arm 78 attached to the ball nut. The locator arm may alternatively be attached a roller screw or other linear actuators to similarly provide precise movement of the locator arm, for locating the metal piece at the precise cutting position. After cutting is performed by the saw, the locator arm 78 may also be actuated to move beyond the saw and push the metal piece back on to the support surface of the stall of the rack assembly 12, thereby re-racking the bar stock. To provide this function, the length locator 76 may have, for example about 36 inches of travel, or more or less and the locator arm may also be longer or shorter, and may have a different shape or size to make sufficient contact and engagement with the metal piece being adjusted.

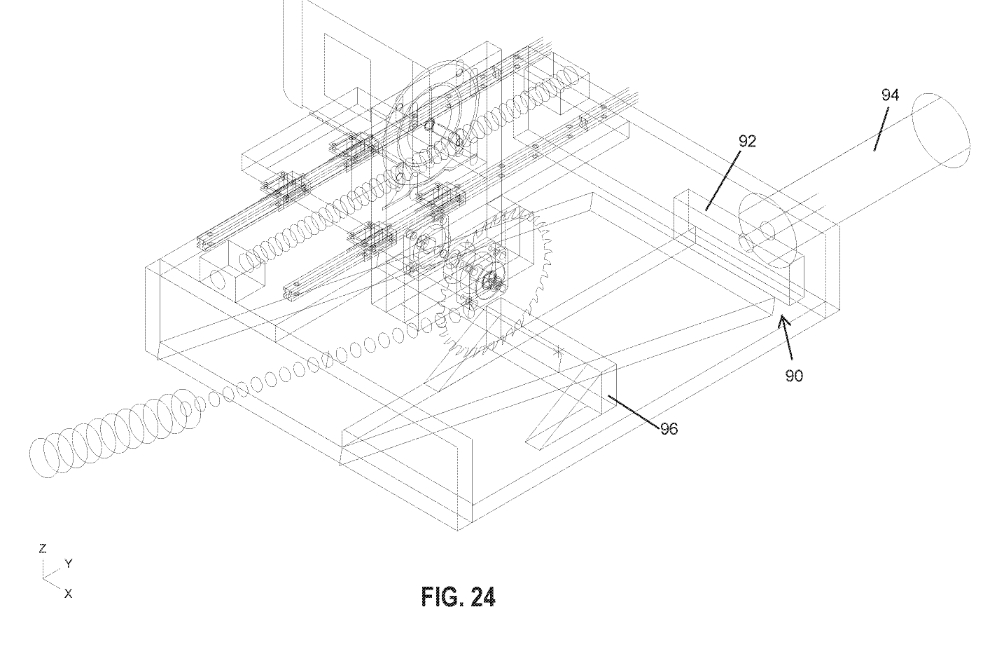

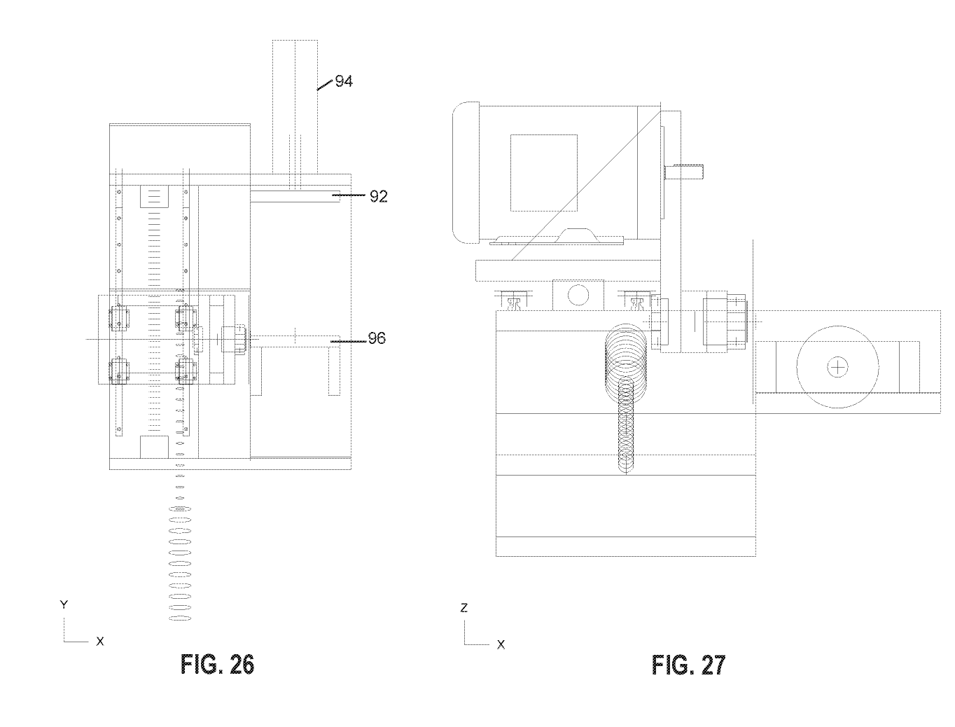

The sawing machine 10 may also include a vise 90 arranged at or near the saw and configured to engage a side of the desired piece of metal in the desired cutting position, allowing the saw to make a clean and square cut through the desired piece of metal. As shown in FIGS. 24 and 26, the vise includes a clamp 92 member powered by a cylinder 94 that is actuated to push the metal piece against a lateral stop 96 to generate resistance and clamping force of the vise. Optionally, the vise may be movable to a resistance position that engages the piece of metal at a first pressure that may be overcome by the pusher device or the length locator, but is greater enough to prevent momentum of the metal piece from moving the piece of metal past the desired cutting position. Further, the vice may then be moveable to a secure position that applies a greater pressure when the desired piece of metal is in the desired cutting position, which prevents the metal piece from moving during cutting. The clamping force may alternatively be generated by other clamps or vise arrangements.

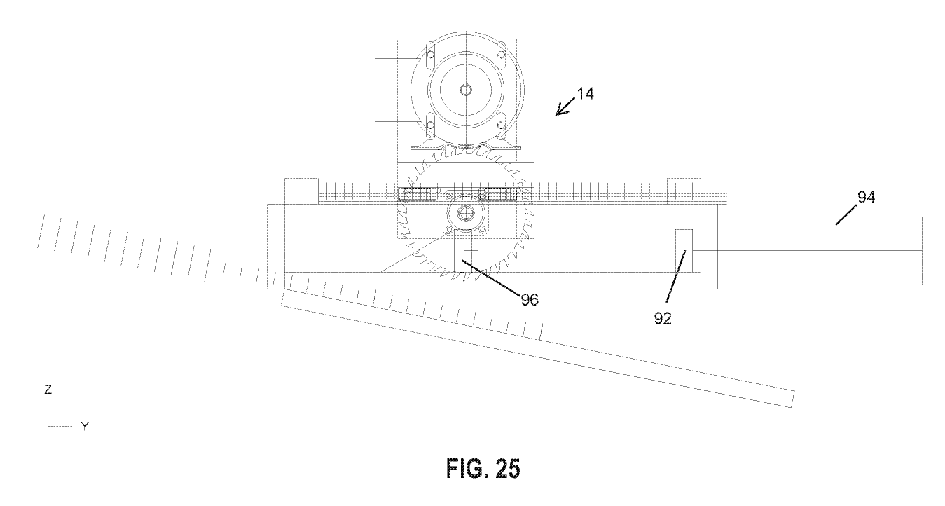

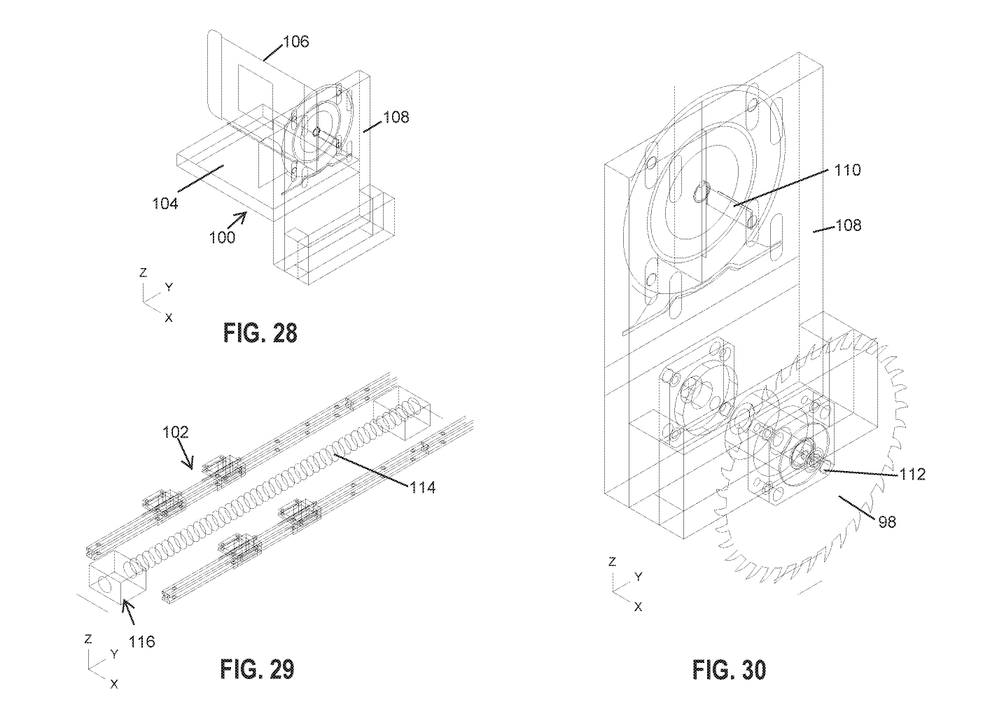

Upon locating the metal piece at the desired cutting position, the sawing machine 10 actuates the saw 14 or cutting device or the like to cut the metal piece at the desired length. The cutting device preferably includes a circular saw, but may also include a band saw, laser cutter, plasma cutter, water jet cutter, and other conceivable cutting devices that employ a corresponding cutting element, such as a saw blade or laser beam, to make the cuts. As shown in FIGS. 25-30, a circular saw is arranged at or near the end of the rack assembly to perform the cut. Accordingly, the saw blade 98 is generally positioned perpendicular to the elongated pieces of metal held by the rack assembly and fed to the saw. The saw blade 98 is conceivably a carbide tip saw blade that may readily be sharpened for extended use. However, other types of saws and blades may be utilized to make the cuts, depending on the material type and size.

In the illustrated example, the saw assembly 14 includes a saw motor mount 100 that attaches to a slide rail assembly 102. The motor mount has a platform 104 for attaching the saw motor 106 and a blade portion 108 attached orthogonally to an edge of the platform. The rotor 110 of the motor extends through the blade portion of the motor mount to operably engage a belt or chain that extends down to couple with a shaft 112 of the saw blade. The saw blade 98 may be moved linearly along the sider assembly by a ball screw 114 arrangement that is powered by a servo motor, which drives the saw at a desired speed. The rotational speed of the saw blade along with the speed the saw moves through the metal piece can be adjusted and calibrated for the material type, thickness, and blade of the saw for providing quality cuts.

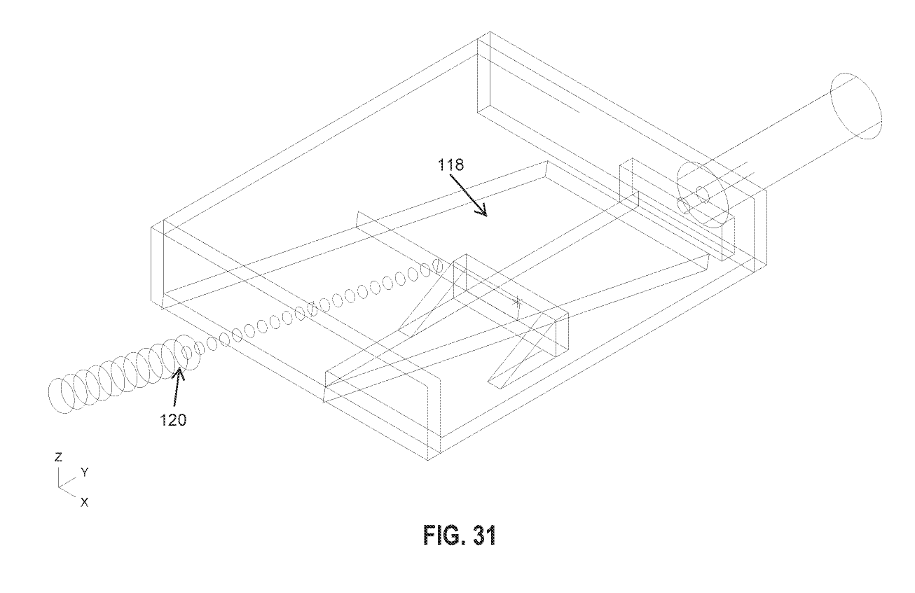

Optionally, after a cut is made, the saw assembly may include a door or drop down ejection shoot that leads to a storage area 118 or compartment for collecting cut parts. As shown in FIG. 31, the storage container may have an angled bottom surface for the cut parts to collect. These parts may also be dispensed from the storage area with a push out cylinder 120, as shown in FIG. 31.

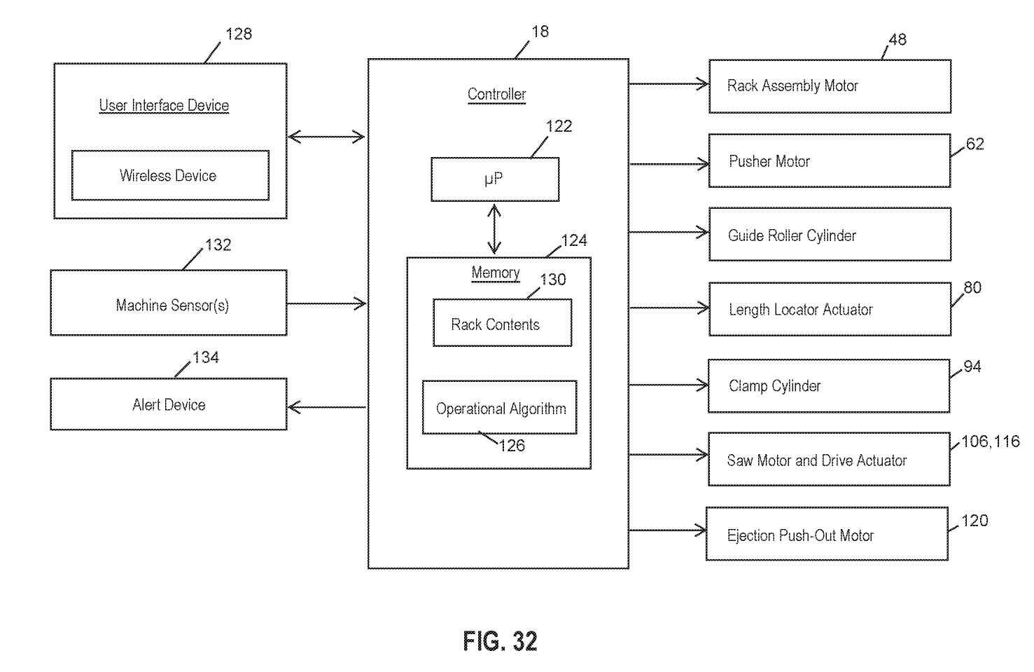

With respect to the operational control of the sawing machine, the controller 18 may be configured to operate the sawing machine by one or multiple users. The controller of the sawing machine 10 may include a microprocessor 122 and/or other analog and/or digital circuitry for processing one or more routines or algorithms to operate the sawing machine as desired. Additionally, the controller 18 may include memory 124 for storing one or more routines or algorithms, including an operational algorithm 126. It should be appreciated that the controller may be a standalone dedicated controller, multiple separate controllers, or may be a shared controller integrated with other control functions, such as integrated with the user interface device 128, such as a wireless device, to process the user inputs and perform related functionality. An exemplary control schematic is shown in FIG. 32, which receives inputs from the user and operate the sawing machine as desired. As illustrated, the controller may receive a part order input from a user, such as from the user interface device. The part order or specification input may identify a desired cut length of a desired piece of metal. Based on the input from the user, the controller can operate to identify the selected stall of the plurality of stalls having the desired piece of metal. This may be done by the controller accessing the rack contents 130 stored in a memory unity of the controller and/or receiving input from sensors 132 on the rack assembly that measure or otherwise identify the metal pieces on each stall. The controller may further actuate the chain drive to move the selected stall to the pushing position, and actuate the pusher device to move the desired piece of metal to the desired cutting position, whereby a portion of the desired piece of metal extends past the saw blade the desired cutting length.

Optionally, the elongated pieces of metal held by the plurality of stalls may have different characteristics, such as gauge, length, and material type, which may be stored by the controller and automatically updated after the saw cuts off a piece of metal, such as updating the stored rack contents. Optionally, the part order input may also include a desired quantity, such that the controller may actuate the pusher and the saw to cut the desired piece of metal at the desired length multiple times to provide the desired quantity.

Optionally, the controller may be configured to receive and process a plurality of part orders having a different desired material, length, and/or quantity. Further, the controller may be operable to determine whether the elongated pieces of metal held on the rack assembly are adequate to satisfy the part order, and optionally, generate an alert to the user, such as a flashing light or siren from the alert device 134, when contents of the rack assembly are insufficient to satisfy the part order.

Changes and modifications in the specifically described embodiments may be carried out without departing from the principles of the present invention, which is intended to be limited only by the scope of the appended claims as interpreted according to the principles of patent law.

1. A sawing machine for cutting steel bar stock, said sawing machine comprising:
a rack assembly having a plurality of stalls that are each configured to hold at least one elongated piece of metal in generally parallel alignment with elongated pieces of metal held by the adjacent stalls;
a chain drive coupled with the plurality of stalls and operable to move the plurality of stalls to align a selected stall of the plurality of stalls with a pushing position;
a saw arranged at or near a first end of the rack assembly and having a saw blade positioned perpendicular to the elongated pieces of metal held by the rack assembly; and
a pusher device having a pusher member coupled with a powered actuator that is operable to linearly move the pusher member from a second end of the rack assembly toward the first end, wherein the pusher member is aligned with the selected stall in the pushing position to contact an end of the elongated piece of metal held by the selected stall and move the elongated piece of metal to a desired cutting position.

2. The sawing machine of claim 1, further comprising:
a controller operable to (i) receive a part order input from a user identifying a desired piece of metal with a desired length, (ii) identify the selected stall of the plurality of stalls having the desired piece of metal, (iii) move the selected stall to the pushing position, and (iv) move the desired piece of metal with the pusher device to the desired cutting position, so that a portion of the desired piece of metal extends past the saw blade the desired length.

3. The sawing machine of claim 2, wherein the elongated pieces of metal held by the plurality of stalls have different characteristics, and wherein the controller stores the characteristics of the elongated pieces of metal held by the plurality of stalls.

4. The sawing machine of claim 2, wherein the controller stores a length measurement of the elongated piece of metal held by each stall of the plurality of stalls and updates the length measurement of the piece of metal held by the selected stall after the desired length is cut off by the circular saw.

5. The sawing machine of claim 2, wherein the part order input includes a desired quantity, and wherein the controller is operable to actuate the pusher device and the saw multiple times to position and cut the desired piece of metal for providing the desired quantity of cut pieces.

6. The sawing machine of claim 5, wherein the controller is configured to receive and process a plurality of part orders having at least one of a different desired piece of metal, a different desired length, and a different quantity.

7. The sawing machine of claim 2, wherein the controller is operable to (i) determine whether the elongated pieces of metal held on the rack assembly are adequate to satisfy the part order and (ii) generate an alert to the user when contents of the rack assembly are insufficient to satisfy the part order.

8. The sawing machine of claim 1, further comprising:
a length locator arranged on an opposing side of the circular saw from the rack assembly, the length locator having a locator arm that is movable to a stop position based on the desired cutting position to provide a precise length adjustment, wherein the locator arm abuts an end of the desired piece of metal opposite the end engaged by the pusher member.

9. The sawing machine of claim 1, further comprising:
a vise arranged at or near the saw and configured to engage a side of the desired piece of metal in the desired cutting position, allowing the saw to make a clean and square cut through the desired piece of metal.

10. The sawing machine of claim 9, wherein the vise is movable to a resistance position that engages the side of the desired piece of metal at a first pressure that is overcome by the pusher device to prevent moving the desired piece of metal past the desired cutting position, wherein, when the desired piece of metal in the desired cutting position, the vise is moveable to a secure position with a second pressure greater than the first pressure.

11. A sawing machine for cutting steel bar stock, said sawing machine comprising:
a rack assembly having a base structure coupled with a plurality of stalls that are configured to hold elongated pieces of metal in generally parallel alignment with each other, wherein the plurality of stalls are movable relative to the base structure to move a selected stall of the plurality of stalls to a pushing position;
a cutting device arranged at or near a first end of the rack assembly and having a cutting element configured to cut the elongated pieces of metal held by the rack assembly;
a pusher device having a pusher member coupled with a chain drive that is operable to linearly move the pusher member from a second end of the rack assembly toward the first end, wherein the pusher member is aligned with the selected stall in the pushing position to contact an end of an elongated piece of metal held by the selected stall and move the elongated piece of metal to a desired cutting position; and
a controller operable to (i) receive an input identifying a desired piece of metal with a desired length, (ii) identify the selected stall of the plurality of stalls having the desired piece of metal, (iii) actuate the rack assembly to move the selected stall to the pushing position, and (iv) actuate the pusher device to move the desired piece of metal to the desired cutting position, where a portion of the desired piece of metal extends past the cutting element the desired length.

12. The sawing machine of claim 11, wherein the plurality of stalls of the rack assembly include a first and second set of vertically arranged shelves that are coupled with an adjustment device that allows the first and second sets to counterbalance each other, wherein operation of the adjustment device to move the first set of vertically arranged shelves upward causes the second set of vertically arranged shelves to move downward an substantially equal distance.

13. The sawing machine of claim 12, wherein the chain drive of the pusher device extends longitudinally between the first and second sets of vertically arranged shelves, and wherein the pusher member is pivotal about a longitudinal axis between a first position that engages an elongated piece of metal on the first set of vertically arranged shelves and a second position that engages an elongated piece of metal on the second set of vertically arranged shelves.

14. The sawing machine of claim 11, wherein the controller stores a length measurement of the elongated piece of metal held by each stall of the plurality of stalls and updates the length measurement of the piece of metal held by the selected stall after the desired length is cut off by the cutting element of the cutting device.
